(19) United States
(12) Patent Application Publication
(10) Pub. No.: US 2013/0043855 A1
(43) Pub. Date: Feb. 21, 2013

(54) POWER SUPPLY DEVICE AND METHOD THEREOF

(71) Applicant: Te-Lung Wu, New Taipei City (TW)

(72) Inventor: Te-Lung Wu, New Taipei City (TW)

(73) Assignee: WISTRON CORP., New Taipei City (TW)

(21) Appl. No.: 13/252,873

(22) Filed: Oct. 4, 2011

(30) Foreign Application Priority Data
Aug. 16, 2011 (TW) 100129159

(51) Int. Cl. G05F 1/618

(52) U.S. Cl. 323/284

(57) ABSTRACT

A power supply device generating an output voltage and including a first switching module, a second switching module, a detection module, a pulse width modulation (PWM) module and an energy storage filter module is disclosed. The first switching module is coupled between a first voltage source and a switching node. The second switching module is coupled between the switching node and a second voltage source. The detection module detects voltage of the switching node. The PWM module generates a first PWM signal and transmits the first PWM signal to the first switching module according to a detection result of the detection module. The energy storage filter module processes the voltage of the switching node to generate the output voltage.

### CROSS REFERENCE TO RELATED APPLICATIONS

This Application claims priority of Taiwan Patent Application No. 100129159, filed on Aug. 16, 2011, the entirety of which is incorporated by reference herein.

### BACKGROUND OF THE INVENTION

1. Field of the Invention

The invention relates to a power supply device and method, and more particularly to a power supply device and method of generating an output voltage according to voltage of a switching node.

2. Description of the Related Art

In current electric products, performances of the electric products are advanced. Power requirements of electric products have increased. To satisfy power requirements, each electric product comprises a power supply device to transform power. However, when performance and power number of the electric product are increased, latent power consumption and latent EMI questions are troublesome.

### BRIEF SUMMARY OF THE INVENTION

In accordance with an embodiment, a power supply device generates an output voltage and comprises a first switching module, a second switching module, a detection module, a pulse width modulation (PWM) module and an energy storage filter module. The first switching module is coupled between a first voltage source and a switching node. The second switching module is coupled between the switching node and a second voltage source. The detection module detects voltage of the switching node. The PWM module generates a first PWM signal and transmits the first PWM signal to the first switching module according to a detection result of the detection module. The energy storage filter module processes the voltage of the switching node to generate the output voltage.

In accordance with an exemplary embodiment, a power supply method is described in the following. The power supply method provides an output voltage and is applied with a first switching module coupled between a first voltage source and a switching node and a second switching module coupled between the switching node and a second voltage source. Voltage of the switching node is detected. A first PWM signal is generated according to a result of detecting the voltage of the switching node and transmitted to the first switching module. The voltage of the switching node is processed to generate the output voltage.

A detailed description is given in the following embodiments with reference to the accompanying drawings.

### BRIEF DESCRIPTION OF THE DRAWINGS

The invention can be more fully understood by referring to the following detailed description and examples with references made to the accompanying drawings, wherein:

FIG. 1 is a schematic diagram of an exemplary embodiment of a power supply device of the invention;

FIGS. 2 and 3 are schematic diagrams of other exemplary embodiments of the power supply device of the invention; and

FIG. 4 is a schematic diagram of an exemplary embodiment of a power supply method of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

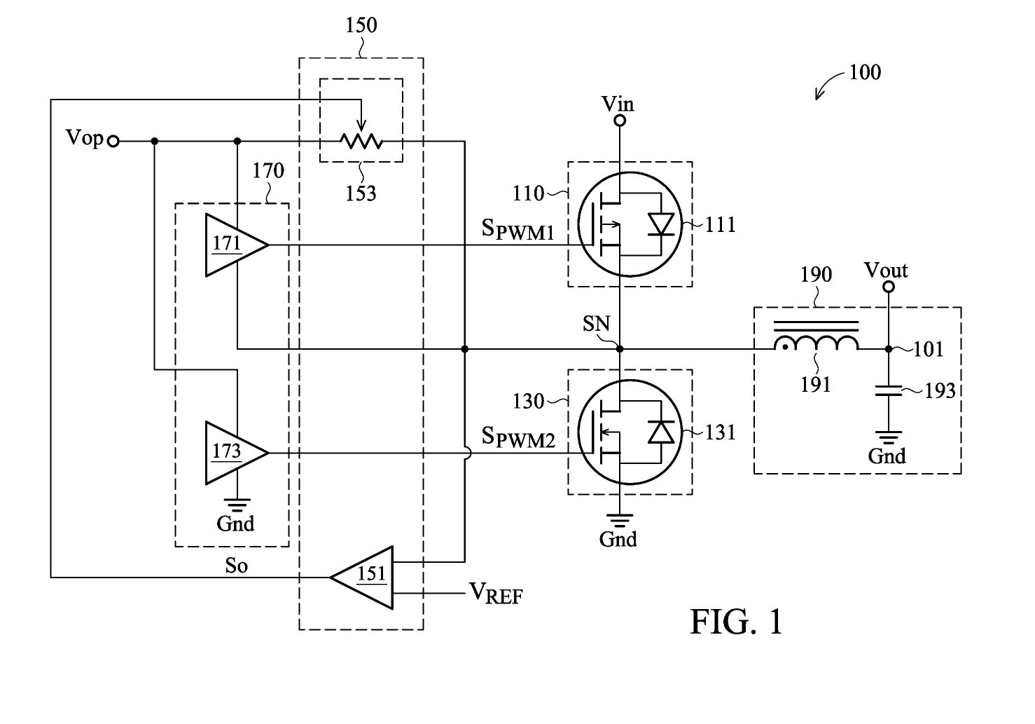

FIG. 1 is a schematic diagram of an exemplary embodiment of a power supply device of the invention. In this embodiment, the power supply device 100 is capable of transforming power to generate an output voltage Vout to a load (not shown).

As shown in FIG. 1, the power supply device 100 comprises switching modules 110, 130, a detection module 150, a pulse width modulation (PWM) module 170, and an energy storage filter module 190. The switching module 110 is coupled between a first voltage source (not shown) and a switching node SN. The first voltage source provides voltage (e.g. an input voltage Vin) to the switching module 110. The switching module 130 is coupled between the switching node SN and a second voltage source (not shown). The second voltage source may provide another voltage (e.g. an input voltage Gnd) to the switching module 130. In one embodiment, the input voltage Vin exceeds the input voltage Gnd. The input voltage Gnd may be a ground voltage.

The invention does not limit the kinds of the switching modules 110 and 130. In one embodiment, the switching modules 110 and 130 are composed of transistors. For example, the switching modules 110 and 130 are P-type transistors or N-type transistors. In other embodiments, one of the switching modules 110 and 130 is a P-type transistor and another is an N-type transistor.

In this embodiment, the switching module 110 is a P-type transistor 111, and the switching module 130 is an N-type transistor 131. As shown in FIG. 1, the P-type transistor 111 comprises a gate receiving a PWM signal S_{PWM1}, a source receiving the input voltage Vin and a drain coupled to the switching node SN. The N-type transistor 131 comprises a gate receiving another PWM signal S_{PWM2}, a source receiving the input voltage Gnd and a drain coupled to the switching node SN.

The detection module 150 detects the voltage of the switching node SN. The PWM module 170 generates a PWM signal S_{PWM1} and transmits the PWM signal S_{PWM1} to the switching module 110 according to a detection result generated by the detection module 150. In this embodiment, the detection module 150 is not integrated with the PWM module 170. In other embodiments, the detection module 150 is integrated into the PWM module 170.

The invention does not limit the circuit structure of the detection module 150. Any circuit can serve as the detection module 150, as long as the circuit is capable of detecting the voltage of the switching node SN and utilizing the detection result to activate the PWM module 170 such that the PWM module 170 generates the appropriate PWM signal S_{PWM1} and transmits the appropriate PWM signal S_{PWM1} to the switching module 110.

In this embodiment, the detection module 150 comprises a comparator 151 and a variable resistor 153. As shown in FIG. 1, the variable resistor 153 is coupled to the PWM module 170. The comparator 151 compares the voltage of the switching node SN and a pre-determined value V_{REF} (e.g. 24V) and generates an output signal So to adjust the resistance of the variable resistor 153.

The PWM module 170 adjusts the driving capability of the PWM signal S_{PWM1} according to the resistance of the variable resistor 153. For example, when the voltage of the switching node SN is less than the pre-determined value V_{REF}, the comparator 151 reduces the resistance of the variable resistor 153. Thus, the PWM module 170 increases the driving capability of the PWM signal S_{PWM1}. Contrarily, when the voltage of the switching node SN is higher than the pre-determined value V_{REF}, the comparator 151 increases the resistance of the variable resistor 153. Thus, the PWM module 170 reduces the driving capability of the PWM signal S_{PWM1}.

In this embodiment, the PWM module 170 comprises drivers 171 and 173. The driver 171 generates the PWM signal S_{PWM1} according to the resistance of the variable resistor 153. The switching module 110 is turned on or off according to the PWM signal S_{PWM1}. The driver 173 generates the PWM signal S_{PWM2} according to an operation voltage Vop. The switching module 130 is controlled to turn on or off according to the PWM signal S_{PWM2}.

The energy storage filter module 190 stores and filters the voltage of the switching node SN to generate the output voltage Vout. In this embodiment, the energy storage filter module 190 comprises an inductor 191 and a capacitor 193. The inductor 191 is coupled between the switching node SN and a voltage node 101. The capacitor 193 is coupled between the voltage node 101 and the input voltage Gnd. The output voltage Vout is output from the voltage node 101.

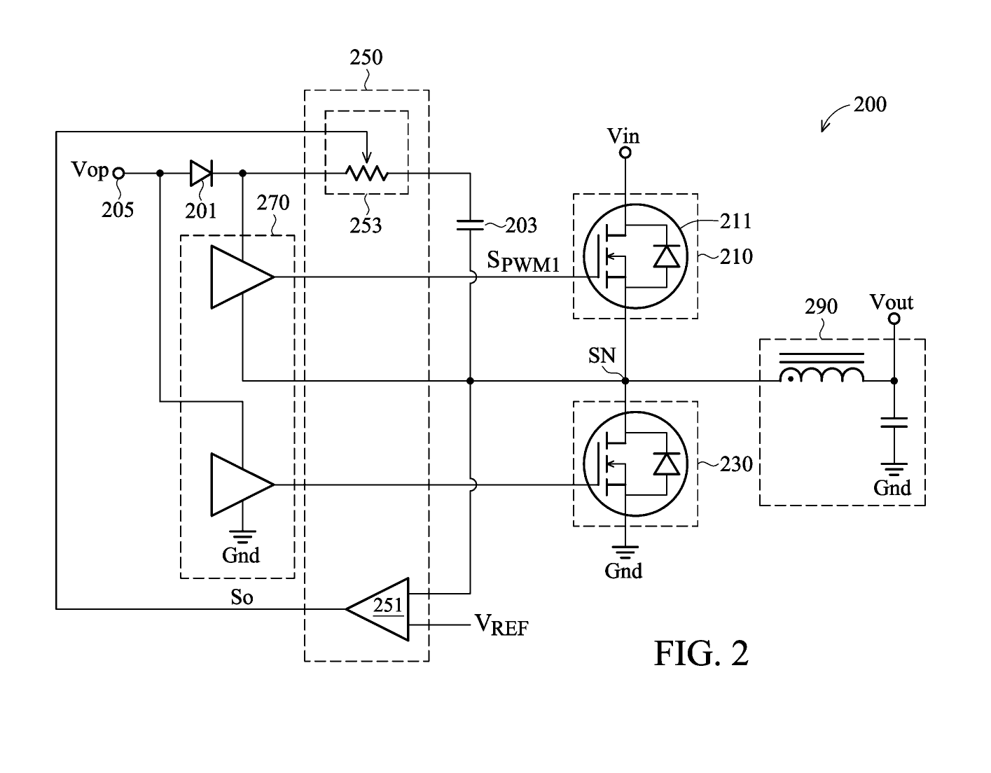

FIG. 2 is a schematic diagram of another exemplary embodiment of the power supply device of the invention. FIG. 2 is similar to FIG. 1 with the exception that the power supply device 200 further comprises a diode 201 and a capacitor 203, and the switching module 210 is different from the switching module 110. Since the switching modules 130, 230, the detection modules 150, 250, the PWM modules 170, 270 and the energy storage filter modules 190, 290 have the same principles, descriptions of the switching module 230, the detection module 250, the PWM module 270 and the energy storage filter module 290 are omitted for brevity.

In this embodiment, the diode 201 has an isolation function to prevent the operation voltage Vop from being influenced by the voltage of the switching node SN. Additionally, the capacitor 203 makes the status of the switching node SN to be a virtual ground status such that the PWM module 270 can normally control the switching module 210. As shown in FIG. 2, the diode 201 is coupled between a voltage node 205 and a variable resistor 253. The voltage node 205 receives the operation voltage Vop. The capacitor 203 is coupled between the variable resistor 253 and the switching node SN.

In FIG. 2, the switching module 210 is composed of an N-type transistor 211. The N-type transistor 211 comprises a gate receiving the PWM signal S_{PWM1}, a drain receiving the input voltage Vin and a source coupled to the switching node SN. The N-type transistor 211 operates according to the PWM signal S_{PWM1}. For example, when the voltage difference between the gate and the source of the N-type transistor 211 is higher than the threshold voltage of the N-type transistor 211, the N-type transistor 211 can be turned on. Thus, the voltage of the switching node SN is approximately equal to the input voltage Vin.

When the voltage of the switching node SN is higher than a pre-determined value V_{REF}, the comparator 251 generates an output signal So to increase the resistance of the variable resistor 253. Thus, the PWM module 270 reduces the driving capability of the PWM signal S_{PWM1}. On the contrary, when the voltage of the switching node SN is less than the pre-determined value V_{REF}, the resistance of the variable resistor 253 is reduced according to the output signal So. Thus, the PWM module 270 increases the driving capability of the PWM signal S_{PWM1}.

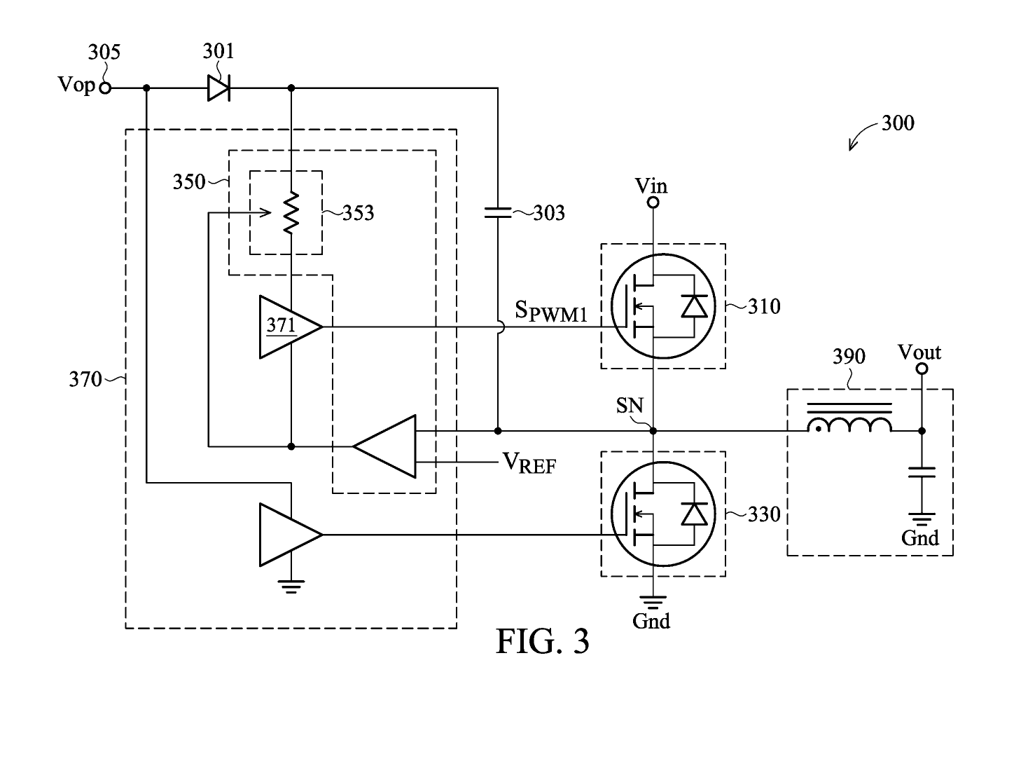

FIG. 3 is a schematic diagram of another exemplary embodiment of the power supply device of the invention. FIG. 3 is similar to FIG. 2 with the exception that the detection module 350 is integrated with the PWM module 370. Since the switching modules 210, 230, 310, 330, the PWM modules 270, 370 and the energy storage filter modules 290, 390 have the same principles, descriptions of the switching modules 310, 330, the PWM module 370 and the energy storage filter module 390 are omitted for brevity.

In this embodiment, a diode 301 is serially coupled to a capacitor 303 between the voltage node 305 and the switching node SN. The voltage node 305 receives an operation voltage Vop. The variable resistor 353 is coupled between the cathode of the diode 301 and the driver 371. The driver 371 appropriately adjusts the driving capability of the PWM signal S_{PWM1} according to the resistance of the variable resistor 353. Thus, the ringing events of the switching node SN and EMI questions can be restrained.

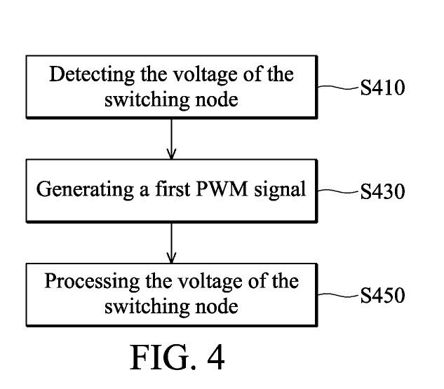

FIG. 4 is a schematic diagram of an exemplary embodiment of a power supply method of the invention. The power supply method provides an output voltage and is applied to a first switching module and a second switching module. The first switching module is coupled between a first voltage source and a switching node. The second switching module is coupled between the switching node and a second voltage source. In one embodiment, the first voltage source provides a first input voltage, and the second voltage source provides a second input voltage. The second input voltage may be less than the first input voltage.

First, voltage of the switching node is detected (step S410). In one embodiment, the voltage of the switching node is compared with a pre-determined value. The compared result is utilized to adjust resistance of a variable resistor. For example, when the voltage of the switching node is higher than the pre-determined value, the resistance of a variable resistor is increased. On the contrary, when the voltage of the switching node is less than the pre-determined value, the resistance of a variable resistor is reduced.

A first PWM signal is generated according to a detection result generated by step S410, and the first PWM signal is transmitted to the first switching module (step S430). For example, when the voltage of the switching node is higher than the pre-determined value, the resistance of the variable resistor is increased. Thus, a first PWM signal with low driving capability is generated. On the contrary, when the voltage of the switching node is less than the pre-determined value, the resistance of the variable resistor is reduced. Thus, a first PWM signal with high driving capability is generated

The voltage of the switching node is processed to generate an output voltage (step S450). In one embodiment, an energy storing filtering action is executed for the voltage of the switching node to generate an appropriate output voltage to a load according to the voltage of the switching node.

In other embodiments, an operation voltage is utilized to generate a second PWM signal to turn on or off the second switching module. Since the voltage of the switching node is restrained to within an optimum range, a great voltage does not occur for the second switching module.

In another embodiment, an isolator is disposed to prevent the operation voltage to be influenced by the voltage of the switching node. Additionally, the status of the switching node is set to a virtual ground status.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A power supply device for generating an output voltage, comprising:
a first switching module coupled between a first voltage source and a switching node;
a second switching module coupled between the switching node and a second voltage source;
a detection module for detecting voltage of the switching node;
a pulse width modulation (PWM) module for generating a first PWM signal and transmitting the first PWM signal to the first switching module according to a detection result of the detection module; and
an energy storage filter module for processing the voltage of the switching node to generate the output voltage.

2. The power supply device as claimed in claim 1, wherein the detection module comprises:
a variable resistor coupled to the PWM module; and
a comparator for comparing the voltage of the switching node with a pre-determined value and accordingly generating an output signal to adjust resistance of the variable resistor, wherein the PWM module generates the first PWM signal according to the resistance of the variable resistor.

3. The power supply device as claimed in claim 2, wherein the PWM module comprises:
a first driver for generating the first PWM signal according to the resistance of the variable resistor; and
a second driver for generating the second PWM signal and transmitting the second PWM signal to the second switching module according to an operation power.

4. The power supply device as claimed in claim 3, wherein the first switching module is a P-type transistor and the second switching module is a N-type transistor.

5. The power supply device as claimed in claim 3, wherein the first switching module is a first N-type transistor, and the second switching module is a second N-type transistor.

6. The power supply device as claimed in claim 3, further comprising:
a diode for preventing the operation power to be influenced by the voltage of the switching node; and
a capacitor for causing a status of the switching node to be a virtual ground status.

7. The power supply device as claimed in claim 6, wherein the diode is coupled between a voltage node and the variable resistor, the capacitor is coupled between the variable resistor and the switching node, and the voltage node receives the operation voltage.

8. The power supply device as claimed in claim 6, wherein the diode is serially coupled to the capacitor between a voltage node and the switching node, and the voltage node receives the operation power.

9. The power supply device as claimed in claim 1, wherein the detection module is integrated with the PWM module.

10. The power supply device as claimed in claim 1, wherein the energy storage filter module comprises:
an inductor coupled between the switching node and a voltage node, wherein the output voltage is output from the voltage node; and
a capacitor coupled between the voltage node and the second voltage source.

11. A power supply method for providing an output voltage and applying in a first switching module coupled between a first voltage source and a switching node and a second switching module coupled between the switching node and a second voltage source, comprising:
detecting voltage of the switching node;
generating a first PWM signal according to a result of detecting the voltage of the switching node and transmitting the first PWM signal to the first switching module; and
processing the voltage of the switching node to generate the output voltage.

12. The power supply method as claimed in claim 11, wherein the step of detecting the voltage of the switching node comprises:
comparing the voltage of the switching node with a pre-determined value; and
adjusting resistance of a variable resistor according to the compared result

13. The power supply method as claimed in claim 12, further comprising:
generating a second PWM signal and transmitting the second PWM signal to the second switching module according to an operation voltage.

14. The power supply method as claimed in claim 13, further comprising:
disposing an isolation device to prevent the operation voltage to be influenced by the voltage of the switching node; and
by the voltage of the switching node; and causing the statue of the switching node to be a virtual ground statue.
